(19) United States
(12) Patent Application Publication
(10) Pub. No.: US 2025/0285186 A1
(43) Pub. Date: Sep. 11, 2025

(54) GUIDED CONTENT RECOMMENDATION USING A KNOWLEDGE GRAPH

(71) Applicant: FMR LLC, Boston, MA (US)

(72) Inventors: Lei Zhang, Chapel Hill, NC (US); Richard J. Lyons, III, Boston, MA (US); Chander Puri, Apex, NC (US); Benjamin R. Bourque, Center Harbor, NH (US); Brian Thomas Wilson, Cary, NC (US); Nathan Edward Wall, Charlotte, NC (US); Michele Colleen Davis Collins, Providence, RI (US); Jesse Pezzillo, Warwick, RI (US); Annie Ross, Woodland Hills, CA (US); Peri Diamond, Miami, FL (US); Wenlu Yan, Poway, CA (US)

(21) Appl. No.: 18/599,630

(22) Filed: Mar. 8, 2024

(51) Int. Cl. G06Q 40/06

(52) U.S. Cl. CPC G06Q 40/06

(57) ABSTRACT

Methods and apparatuses for guided content recommendation using a knowledge graph include a server which determines a user intent associated with a user interaction request. The server determines a graph state associated with a user of a remote device based upon historical traversal information. The server identifies a seed node of a content recommendation knowledge graph based upon the user intent and the graph state. The server generates a digital content display for presentation at the remote device recommended digital content items from the seed node. The server computing device traverses the knowledge graph from the seed node to a connected node based upon a response to the digital content display, including updating the graph state associated with the user of the remote device.

### TECHNICAL FIELD

This application relates generally to methods and apparatuses, including computer program products, for guided content recommendation using a knowledge graph.

### BACKGROUND

With the rise of computing devices such as smartphones, tablets, and Internet of Things (IoT) devices that offer constant connectivity, activity monitoring and data capture, companies have endeavored to capture a wide range of user-specific information in order to provide personalized data delivery, content recommendations, and guided service to their customers. In one example, a customer use an app on their smartphone to connect to a company's automated chatbot system to ask questions and receive accurate information in response. As the user types in questions and other messages, the chatbot system automatically parses the user's questions to determine the intent of the questions and the most relevant responses to the questions in real time or near real time. However, such systems do not provide a fully customized and guided content recommendation experience for users that leverages the user's intent as determined from session context and user profile information, while also preserving prior state of the user interactions to continue in-progress workflows.

### SUMMARY

Therefore, what is needed are computerized methods and systems that provide for customized, context-relevant content recommendation using domain-specific knowledge graphs designed for efficient real-time traversal during communication sessions between a user and a guided experience system. The techniques described herein advantageously implement a knowledge graph data structure as a mechanism for executing a task-based workflow comprising retrieval and display of specific content items to the user—resulting in user-specific data gathering for generation of content displays and recommendations.

The invention, in one aspect, features a computer system for guided content recommendation using a knowledge graph. The system comprises a plurality of digital content databases, each digital content database comprising one or more digital content items. The system comprises a computer data store comprising (i) historical interaction information for each of a plurality of users and (ii) historical graph traversal information for each of the plurality of users. The system comprises a server computing device in communication with the plurality of digital content databases and the computer data store. The server computing device includes a memory to store computer-executable instructions and a processor that executes the computer-executable instructions. The server computing device determines a user intent associated with a user interaction request received from a remote computing device, including analyzing historical interaction information associated with a user of the remote computing device from the computer data store. The server computing device determines a graph state associated with the user of the remote computing device based upon historical graph traversal information for the user in the computer data store. The server computing device identifies a seed node of a content recommendation knowledge graph based upon the user intent and the graph state, the seed node associated with (i) a task for completion by the user and (ii) one or more recommended digital content items from the digital content item databases. The server computing device generates a digital content display for presentation to the user at the remote computing device using the task and the recommended digital content items from the seed node. The server computing device traverses the content recommendation knowledge graph from the seed node to one of a plurality of connected nodes based upon a response to the digital content display received from the remote computing device, including updating the graph state associated with the user of the remote computing device based upon the traversal.

The invention, in another aspect, features a computerized method of guided content recommendation using a knowledge graph. A server computing device determines a user intent associated with a user interaction request received from a remote computing device, including analyzing historical interaction information associated with a user of the remote computing device. The server computing device determines a graph state associated with the user of the remote computing device based upon historical graph traversal information for the user. The server computing device identifies a seed node of a content recommendation knowledge graph based upon the user intent and the graph state, the seed node associated with (i) a task for completion by the user and (ii) one or more recommended digital content items. The server computing device generates a digital content display for presentation to the user at the remote computing device using the task and the recommended digital content items from the seed node. The server computing device traverses the content recommendation knowledge graph from the seed node to one of a plurality of connected nodes based upon a response to the digital content display received from the remote computing device, including updating the graph state associated with the user of the remote computing device based upon the traversal.

Any of the above aspects can include one or more of the following features. In some embodiments, the content recommendation knowledge graph comprises a plurality of nodes each connected to one or more other nodes in the knowledge graph via an edge, and each node comprising (i) a task for completion by the user and (ii) one or more recommended digital content items from the digital content item databases. In some embodiments, the historical interaction information comprises one or more of: webpages accessed by the user during one or more browsing sessions, and context information for voice call sessions or text chat sessions associated with the user. In some embodiments, the historical graph traversal information comprises one or more of: identification of nodes in the content recommendation knowledge graph associated with one or more completed tasks, and identification of nodes in the content recommendation knowledge graph associated with one or more in-progress tasks.

In some embodiments, the digital content display comprises at least one of the digital content items from the seed node and a feedback element configured to receive a response from the user of the remote computing device. In some embodiments, the digital content items comprise webpages, articles, images, videos, and content cards.

In some embodiments, each node in the content recommendation knowledge graph is mapped to one or more predicted intents. In some embodiments, traversing the content recommendation knowledge graph from the seed node to one of a plurality of connected nodes comprises: identifying one or more of the connected nodes that aligns with the response to the digital content display received from the remote computing device; determining an expected reward value for each identified connected node that a task associated with the connected node is responsive to the user intent; and selecting one of the identified connected nodes for traversal based upon the expected reward values. In some embodiments, the task associated with the connected node comprises a subtask of the task associated with the seed node. In some embodiments, the server computing device determines that the task associated with the seed node is complete upon receiving the response to the digital content display.

Other aspects and advantages of the invention will become apparent from the following detailed description, taken in conjunction with the accompanying drawings, illustrating the principles of the invention by way of example only.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 is a block diagram of a system for guided content recommendation using a knowledge graph.

FIG. 2 is a flow diagram of a computerized method of guided content recommendation using a knowledge graph.

FIG. 3 is a detailed block diagram of an intelligence engine for guided content recommendation using a knowledge graph.

FIG. 4 is a workflow diagram of an exemplary knowledge graph for a retirement planning content recommendation process.

FIG. 5 is a workflow diagram of an exemplary knowledge graph for creating personalized emergency fund goal content.

### DETAILED DESCRIPTION

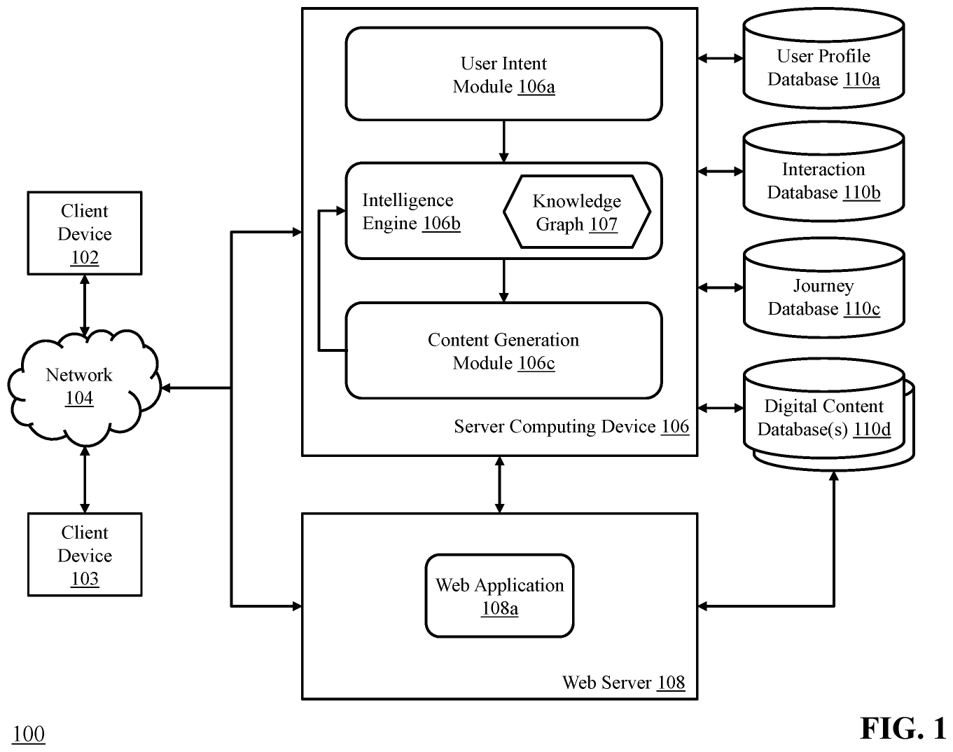

FIG. 1 is a block diagram of system 100 for guided content recommendation using a knowledge graph. System 100 includes client computing device 103, client computing device 103, communication network 104, server computing device 106 that includes user intent module 106a, - -5-- intelligence engine 106b with knowledge graph 107, and content selection module 106c, a web server computing device 108 with web application 108a, and a plurality of databases—user profile database 110a, interaction database 110b, journey database 110c and one or more digital content databases 110d

Client computing devices 102, 103 connect to communication network 104 in order to communicate with server computing device 106 and/or web server 108 to provide input and receive output relating to the process of guided content recommendation using a knowledge graph as described herein. In some embodiments, client computing devices 102, 103 are each coupled to an associated display device (not shown). For example, client computing devices 102, 103 can provide a graphical user interface (GUI) via the display device that is configured to receive input from a user of the device 102, 103 and to present output (e.g., digital content items) to the user that results from the methods and systems described herein.

Exemplary client computing devices 102, 103 include but are not limited to desktop computers, laptop computers, tablets, mobile devices, smartphones, and internet appliances. It should be appreciated that other types of computing devices that are capable of connecting to the components of system 100 can be used without departing from the scope of invention. Although FIG. 1 depicts two client computing devices 102, 103, it should be appreciated that system 100 can include any number of client computing devices.

Communication network 104 enables client computing devices 102, 103 to communicate with server computing device 106 and web server 108. Network 104 is typically a wide area network, such as the Internet and/or a cellular network. In some embodiments, network 104 is comprised of several discrete networks and/or sub-networks (e.g., cellular to Internet).

Server computing device 106 is a device including specialized hardware and/or software modules that execute on one or more processors and interact with memory modules of server computing device 106, to receive data from other components of system 100, transmit data to other components of system 100, and perform functions for guided content recommendation using a knowledge graph as described herein. Server computing device 106 includes user intent module 106a, intelligence engine 106b with knowledge graph 107, and content selection module 106c that execute on one or more processors of server computing device 106. In some embodiments, modules 106a-106c are specialized sets of computer software instructions programmed onto one or more dedicated processors in server computing device 106 and can include specifically designated memory locations and/or registers for executing the specialized computer software instructions.

Although modules 106a-106c and graph 107 are shown in FIG. 1 as executing within the same server computing device 106, in some embodiments the functionality of modules 106a-106c can be distributed among a plurality of server computing devices. As shown in FIG. 1, server computing device 106 enables modules 106a-106c to communicate with each other in order to exchange data for the purpose of performing the described functions. It should be appreciated that any number of computing devices, arranged in a variety of architectures, resources, and configurations (e.g., cluster computing, virtual computing, cloud computing) can be used without departing from the scope of the invention. Exemplary functionality of the modules 106a-106c is described in detail below.

As will be described throughout the specification, knowledge graph 107 comprises one or more multidimensional data structures made up of entities (also called nodes) and relationships (also called edges) that connect the nodes. Generally, knowledge graph 107 comprises business logic and content related to a workflow through which the user is guided, including a plurality of tasks and/or sub-tasks for completion by a user that serves to obtain information from the user and provide content recommendations for the user. Typically, a knowledge graph is associated with a particular topic (e.g., financial planning) that can benefit from customized, guided content recommendations for the user. In some embodiments, the structure knowledge graph 107 is based upon certain defined concepts, including:

Intent: desired activity that a user wants to conduct in a given interaction with web application 108a, e.g., reflects what job the user believes they need to complete next, and enables system 100 to seed the user on knowledge graph 107. Generally, intent can be categorized as explicit intent or implicit intent.
Explicit Intent: an intent determined from captured user input indicating what kind of need, sub-need, or task that the user wants to work on within a given communication session.
Implicit Intent: an intent generated from knowledge about the user (e.g., interaction history, graph state, user profile information) that indicates a predicted likelihood of what need, sub-need, or task that the user wants to work on. Typically, implicit intent is generated without reliance on user input.

Need Node: a higher order job to be completed by a user through interactions with web application 108a. Typically, no digital content items are mapped to a need node.

Sub-Need Node: a lower order job that allows for a more granular level of tasks to be completed. Typically, no digital content items are mapped to a sub-need node.

Criteria Node: a logical gate that allows for directed traversal of knowledge graph 107 depending on satisfaction of certain criteria, such as a predefined rule. Typically, no digital content items are mapped to a criteria node.

Edge: a connection between nodes in knowledge graph 107; enables traversal of the graph to another node depending on evaluation of a rule in a criteria node.

Task: an action for completion by the user. Generally, a task is defined to include both a clear indication of when it is complete, as well as mapping to a customer intent. Typically, digital content items can be mapped to a task node.

Sub-Task: lower-level actions for completion by the user which culminate in the completion of a parent task. Typically, digital content items can be mapped to a sub-task node.

Action: defined configuration of an interaction with a user to elicit user activity.

User Journey: Sequence of tasks (and sub-tasks as applicable) that a user works through to complete a job.

Content: a digital content item or items that are provided to users as part of traversing the knowledge graph. Generally, content comprises a content object (e.g., webpage, image, video, audio, etc.) and content type (e.g., “request information,” “ask question,” “provide information,” “recommend an action or experience,” etc.).

Treatment: a combination of the content and the content type. In some embodiments, a treatment comprises enriched user interface (UI)/user experience (UX) design that allows more types of user input and/or feedback to be collected.

Web server 108 is a computing device (or set of computing devices) to which client computing devices 102, 103 can connect to initiate and conduct communication sessions for interaction with web application 108a for a variety of purposes, such as generating customized guided content recommendations based upon traversal of a knowledge graph, including the creation and receipt of digital content items (such as documents, web pages, and other visual elements) in response to user requests originating at client devices 102, 103. Web server 108 is a combination of hardware, including one or more special-purpose processors and one or more physical memory modules, and specialized software modules (such as web application 108a) that are executed by the one or more processors of web server 108. In some embodiments, web server 108 is an online content platform (such as a website host) that provides certain web application functionality and digital content objects (e.g., text content such as documents, articles, web pages, etc.) to client devices 102, 103. Typically, a website comprises a plurality of visual and non-visual elements that make up the content transmitted and displayed to a user when, e.g., browser software on client computing devices 102, 103 connects to web server 108 via communication network 104 (e.g., Internet) and initiates a communication session with web server 108. The elements of a website include, but are not limited to, webpages (e.g., HTML documents), image files, layouts, color sets, stylesheets, document object models (DOM), tracking elements, metadata, URLs, and content (e.g., text, audio, video).

In one example, a user at client computing device 102 can execute an app installed on the client device to initiate a guided content recommendation session with web application module 108a of web server 108—e.g., for the purpose of generating and receiving customized content recommendations. In one embodiment, web application 108a can be a web-based interactive software application that is configured to retrieve information about a user of client device 102, 103 (e.g., from device 102, 103 and/or databases 110a-110d) to initialize a state-based knowledge graph based upon the information, and traverse the knowledge graph to identify and display specific content to the user of client device 102, 103. In some embodiments, the user at client device 102, 103 can launch an app on client devices 102, 103 (e.g., native app or browser software) to interact with web application 108a. In some cases, web application 108a can communicate with the digital content databases 110d to identify and retrieve relevant digital content (documents, articles, webpages, etc.) that are responsive to interactions received from a user of client devices 102, 103 during the communication session and/or during prior communication sessions.

Databases 110a-110d are located on a computing device (or in some embodiments, on a set of computing devices) coupled to the server computing device 106 and web server 108 and the databases are configured to receive, generate, and store specific segments of data relating to the process of guided content recommendation using a knowledge graph as described herein. In some embodiments, all or a portion of the databases 110a-110d can be integrated with server computing device 106, web server 108, and/or be located on a separate computing device or devices. Databases 110a-110d can comprise one or more databases configured to store portions of data used by the other components of system 100, as will be described in greater detail below.

In some embodiments, user profile database 110a comprises user profile information for a plurality of users of system 100; typically, each user is associated with one or more client computing devices 102, 103. User profile information can include, but is not limited to, domain-specific identification information (e.g., user identifiers, account numbers), name, address, phone number, demographic information, financial information, device information (e.g., IP address, MAC address, etc. of client computing device 102, 103), and the like.

In some embodiments, interaction database 110b comprises historical user action/user event data that may be correlated to user profiles as stored in user profile database 110a. Generally, interaction database 110b can comprise information about prior actions of users (e.g., purchases, requests for information, appointments, account setup, transactions, customer service interactions, etc.) that may be relevant to the initial state and/or traversal of one or more knowledge graphs by the user as stored in journey database 110c. For example, a user that accessed URLs relating to password reset instructions, online account activation FAQs, and other similar topics during a web browsing session may not have been able to find the information they were seeking. As a result, within a short time (e.g., 10 minutes) after participating in the web browsing session, the user may call a customer service center or initiate a virtual support chat session. Therefore, the specific URLs accessed by the user during the web browsing session may be associated with a strong likelihood of subsequent interactions (e.g., calls, web chats, etc.) from the user with the intent of seeking information about account activation or password reset.

In some embodiments, journey database 110c comprises data and/or metadata associated with the current state and traversal options in one or more knowledge graphs for each of the users of system 100. For example, journey database 110c can comprise and/or interact with a Neo4j Graph Database that stores nodes and edges (along with related attributes of each) from which the knowledge graph is constructed. The data corresponding to a particular knowledge graph is exported from Neo4j as a graphml file to be stored in server computing device 106 (i.e., as graph 107), loaded into memory when needed, and queried utilizing a python package, NetworkX. Additional technical information about knowledge graph state and traversal, including initializing and seeding a knowledge graph for traversal of a task-based workflow for a particular user, is described throughout the specification.

In some embodiments, digital content database(s) 110d comprise an online content platform that provides certain digital content objects (e.g., text content such as articles, webpages, etc.; digital media such as videos, podcasts, etc.; alerts such as notification messages, etc.) to client computing devices 102, 103 via web server 108 and web application 108a. Typically, a web application comprises a plurality of visual and non-visual elements that make up the content transmitted and displayed to a user when, e.g., browser software on client computing device 102, 103 connects to web server 108 via communication network 104 (e.g., Internet) and requests content from server 108. The elements of a web application include, but are not limited to, webpages (e.g., HTML documents), image files, layouts, color sets, stylesheets, document object models (DOM), tracking elements, metadata, URLs, and content (e.g., text, audio, video). In some embodiments, web server 108 communicates with an app installed on client computing device 102, 103 to present digital content items to a user of the device via the app. In some instances, database(s) 110d can comprise structured computer text corresponding to the content of each digital content item in conjunction with one or more binary content files that comprise the digital content item itself. For example, digital content databases 110d can include a specialized data structure that maps the structured computer text for a digital content item with one or more pointers or addresses to a network location that stores the one or more binary content files for the corresponding digital content item (e.g., content delivery servers, archive data storage, and the like).

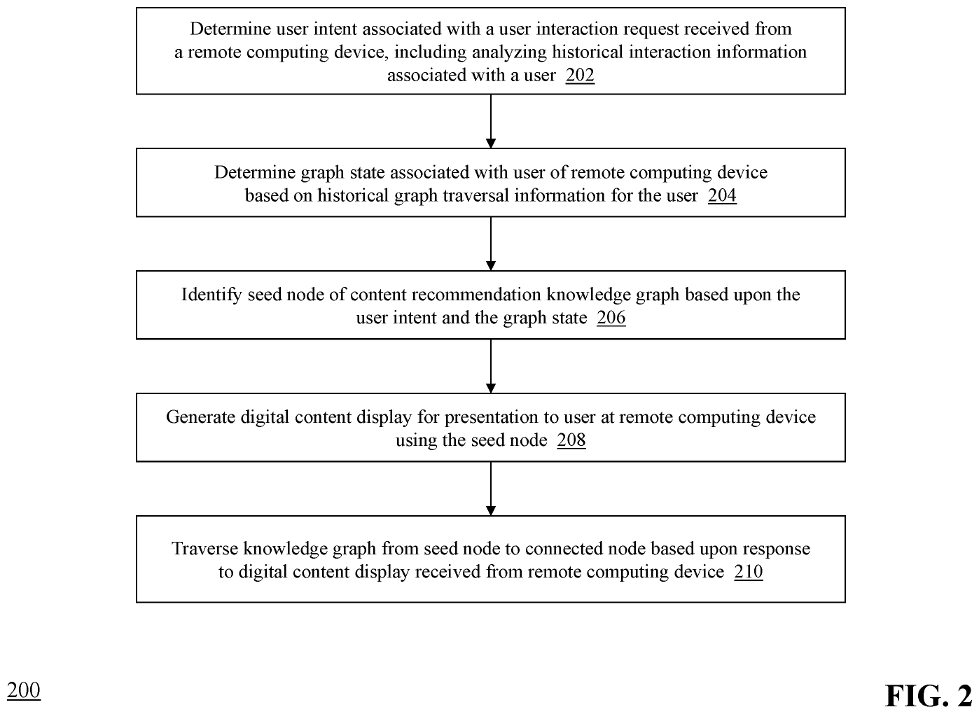

FIG. 2 is a flow diagram of a computerized method 200 of guided content recommendation using a knowledge graph, using system 100 of FIG. 1. A user at a client computing device (e.g., computing device 102) establishes a communication session with web server 108 to interact with web application 108a. As part of this interaction, the user can browse webpages and other content provided by web server 108 and select and receive digital content objects from, e.g., digital content database(s) 110d via web server 108. In some embodiments, the user at client device 102 provides authentication credentials to web server 108 as part of establishing the communication session, and web server 108 uses the authentication credentials to (i) verify that the user is entitled to access one or more features of application 108a, (ii) retrieve one or more data elements from user profile database 110a that are associated with the user, and (iii) configure web application 108a to present personalized content and/or information to the user. In one example, web application 108a can be configured to present a dashboard user interface upon successful authentication of the user at client computing device 102—where the dashboard comprises a summary of information that is associated with the user (e.g., account details, historical interactions, personal information) as well as one or more user interface elements (e.g., links, buttons) that enable the user to interact with web application 108a to access one or more relevant features of the application.

During establishment of the communication session and/or as the user is interacting with web application 108a during the session, client computing device 102 transmits a user interaction request to web server 108. In some embodiments, the user interaction request includes, but is not limited to, a request to access functionality or features of web application 108a or a request to receive content and/or information from web application 108a. An example of a request to access functionality of web application 108a could be a balance transfer initiation request. An example of a request to receive content and/or information from web application 108a could be a query regarding investment options for a retirement plan. In some embodiments, the user may want to continue with an in-progress transaction based upon prior interactions with web application 108a and the user interaction request can include data to indicate to web application 108a that the user intends to resume the transaction during this session.

Web application 108a provides the user interaction request to user intent module 106a of server computing device 106. User intent module 106a determines (202) a user intent associated with the user interaction request, including analyzing historical interaction information associated with the user of client device 102 that is retrieved from interaction database 110b. In some embodiments, user intent module 106a captures session context information from interaction database 110b. The session context comprises a plurality of data elements recorded by web application 108a and/or web server 108 during the current communication session between client computing device 102 and web server 108, as well as data elements recorded by web application 108a and/or web server 108 during prior communication sessions involving the user. As can be appreciated, the prior communication sessions may include client computing device 102 and/or other client devices associated with the user. In some embodiments, the session context information is captured by web server 108 via any of a variety of different data capture techniques—such as URL monitoring (i.e., saving and analyzing the syntax/content of particular webpage URLs that the user navigates to), tracking cookies embedded in webpages, screen scraping, session packet interdiction, database logging, session credential analysis, and the like. The recorded data elements typically comprise content interaction data relating to the content and/or functionality of web application 108a with which the user is interacting during the session. For example, during a communication session, the user may access one or more content articles relating to setting retirement goals. Web server 108 can record certain data elements such as titles of the articles, URLs that point to the articles, metadata associated with the articles (e.g., content tags, keywords), and other information (e.g., date/time at which the user accessed the articles, etc.). Web server 108 can store this information in interaction database 110b.

In some embodiments, the session context information also includes data and/or metadata collected from one or more conversation sessions between the user at client computing device 102 and resources at web server 108 and/or server computing device 106. For example, the user at client computing device 102 can participate in conversations (e.g., text chat, voice chat) with an automated resource provided by web server 108, such as a chatbot, interactive voice response (IVR) system, or other type of conversation service application. Web server 108 can capture the utterances provided by the user during the conversation and store the utterances in, e.g., interaction database 110b. In some embodiments, the conversations occur in real time—for example, as the user is interacting with web application 108a during a communication session.

User intent module 106a analyzes the session context information retrieved from interaction database 110b to determine the user intent (i.e., the reason or goal of the user at client computing device 102 to interact with web server 108 and generate the user interaction request). The session context information can be combined with other data associated with the user, as collected from user profile database 110a and/or interaction database 110b. In some embodiments, user intent module 106a can retrieve user-specific profile information (e.g., demographics, financial profile) from user profile database 110a and analyze the user-specific profile information in conjunction with the session context information when determining the user intent. As will be explained in greater detail below, the session context information and user-specific profile information can be considered as a set of data points that reflects a current state of the user for the purposes of determining a relevant knowledge graph for content recommendation.

In some embodiments, user intent module 106a leverages advanced machine learning techniques and algorithms to determine the user intent from the session context information and user-specific profile information. As described above, user intent module 106a retrieves user profile data, demographics, financial profile information, prior interaction data, real-time conversation data, and other relevant user data from databases 110a-110b and generates one or more machine-readable vector representations comprising user profile attributes and session context attributes that may be deemed relevant to determining user intent. The machine-readable vector representations are then used as input to a machine learning need prediction model to identify a probable user intent. In some embodiments, the machine learning intent prediction model is executed by user intent module 106a. The model can comprise an artificial intelligence algorithm such as a recursive neural network (RNN), a convolutional neural network (CNN), or other type of neural network architecture that comprises a plurality of layers (e.g., input layer, one or more hidden layers, output layer) configured to receive as input the machine-readable vector representations for a given user, and generate one or more predicted user intents based upon the machine-readable vector representations—that is, the model is configured to determine (or predict) a relationship between the features and/or attributes of the input vector representation and a corresponding user intent. Generally, the model is measured by how accurately it can predict the output from the corresponding input—a less accurate model can be retrained using the same training data (and/or additional training data) in order to refine the model and make it more accurate. In some embodiments, the model is a feed forward neural network with several output layers.

In some embodiments, user intent module 106a may not be able to determine a specific user intent based upon the session context information and user-specific profile information. In these instances, user intent module 106a can take any of a variety of approaches to establish the current user state for purposes of identifying a knowledge graph for content recommendation. In one example, user intent module 106a can evaluate historical user intents for the specific user and determine which historical intent may be most relevant to the current session context information and user-specific profile information (e.g., via matching characteristics of the session context to the historical intents). In another example, user intent module 106a can identify one or more other users that share characteristics with the current user—such as demographics, financial profile, historical interactions, etc.—and apply a user intent that was previously determined for the other user(s) to the current user.

Once user intent module 106a has identified a user intent from the session context information and user-specific profile information, intelligence engine 106b determines (step 204) a graph state associated with the user of client computing device 102 based upon historical graph traversal information for the user. In some embodiments, intelligence engine 106b retrieves user-specific information from journey database 110c in order to determine a relevant knowledge graph 107 to use in the present communication session with the user of client computing device 102. As mentioned previously, journey database 110c comprises data and/or metadata associated with the current state and traversal options in one or more knowledge graphs 107 for the users. For example, a user may have previously initiated a journey (i.e., a sequence of tasks/sub tasks that the user follows to complete a particular activity) which leverages a particular knowledge graph to guide the user through retirement planning and provide relevant, customized content recommendations for the user during the journey. In this example, the user may still be working through the retirement planning journey; as such, the journey is considered in-progress for the user. Journey database 110c stores specific information about the state of the knowledge graph for the user at the current in-progress point for the journey. For example, journey database 110c can store the identity of the knowledge graph associated with the current state of the user's journey, as well as the identity of the particular node within the knowledge graph that represents the most recently completed task in the user's in-progress journey. Intelligence engine 106b can capture the graph state from journey database 110c and initialize knowledge graph 107 for the current communication session using information from the graph state.

In some embodiments, the user at client computing device 102 may not currently have an in-progress journey for which intelligence engine 106b can determine a graph state. For example, the user may be a new customer that has not yet started any planning journeys. In this scenario, intelligence engine 106b can still determine a relevant knowledge graph 107 using the session context information and/or user intent and initialize the selected knowledge graph 107 to a graph state that represents the start of the journey for the new customer.

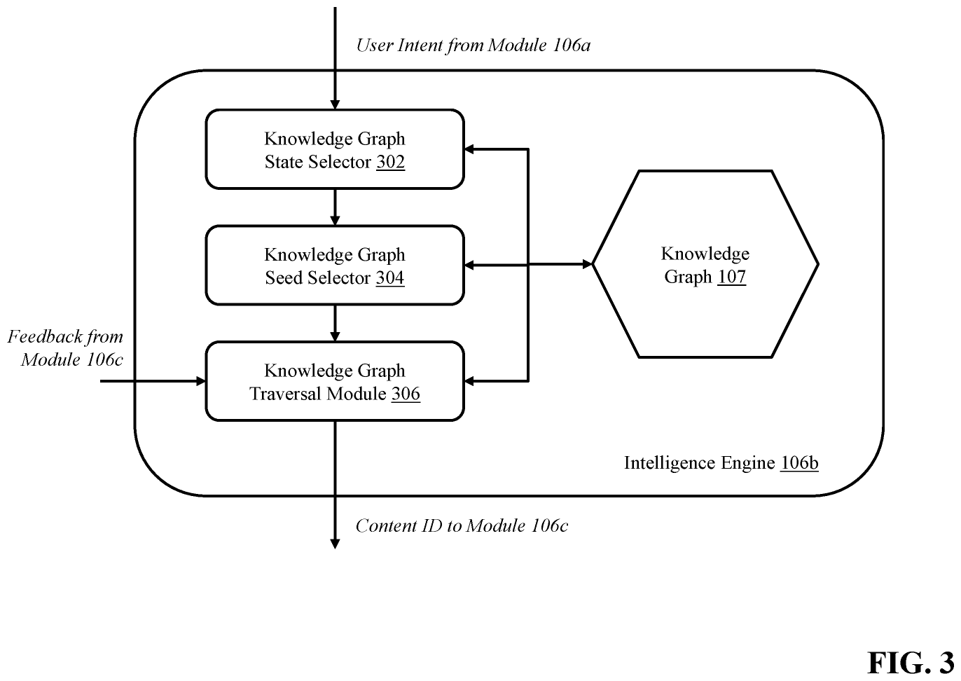

FIG. 3 is a detailed block diagram of intelligence engine 106b. As shown in FIG. 3, intelligence engine 106b includes knowledge graph state selector 302, knowledge graph seed selector 304, and knowledge graph traversal module 306. Each of these modules 302, 304, 306 is coupled to knowledge graph 107. As described above, knowledge graph state selector 302 of intelligence engine 106b interacts with journey database 110c to identify a knowledge graph 107 to use in conjunction with the current communication session with the user of client computing device 102. Knowledge graph state selector 302 also determines the graph state for the identified knowledge graph (i.e., which task(s) and action(s) have already been completed or have not yet been completed by the user). Knowledge graph state selector 302 then initializes knowledge graph 107 according to the graph state so that continued traversal of the knowledge graph 107 can occur during the current communication session.

Knowledge graph seed selector 304 then identifies (step 206) a seed node of knowledge graph 107 based upon the user intent as determined by user intent module 106a and the graph state as determined by state selector 302. In some embodiments, knowledge graph seed selector 304 can translate the user intent received from module 106a to correspond to a node in knowledge graph 107—in one instance, seed selector 304 can map the user intent to a particular node using a mapping table stored in journey database 110c. For example, the intent ‘create retirement goal’ may be mapped to a particular node ID in knowledge graph 107 and seed selector 304 can determine the node ID to be used as the seed node in knowledge graph 107 for the current communication session. As can be appreciated, the graph state also directs seed selector 304 when determining the seed node. For example, the graph state retrieved from journey database 110c can indicate that the user had previously completed three out of six tasks in the identified knowledge graph-meaning that the journey (e.g., the traversal of the knowledge graph) is still in progress. Seed selector 304 can initialize the selected knowledge graph using the graph state and identify a subset of one or more nodes in the knowledge graph that are seed node candidates. Then, using the user intent, seed selector 304 can identify one of the candidate nodes to be used as the seed node for traversal of the knowledge graph. In some embodiments, seed selector 304 uses a ranking function to order the candidate nodes for selection as the seed node. For example, each of the candidate nodes may be associated with a expected reward value of relevance to the current customer interaction and seed selector 304 can rank the candidates according to the prediction (e.g., from most relevant to least relevant) and select the highest-ranking candidate node as the seed node.

Generally, the seed node identified by seed selector 304 is associated with (i) a task for completion by the user and (ii) one or more recommended digital content items, as stored in digital content database(s) 110d. As just one example, a seed node for an in-progress retirement planning journey may involve requesting information from the user of client computing device 102—such as asking the user for his or her preferred retirement age. Therefore, the task for this seed node is ‘request retirement age for user’ and the digital content can be a webpage or user interface screen with elements that, when presented to the user via client device 102, enable the user to enter the preferred retirement age and submit the response to intelligence engine 106b (via web application 108a) for continued traversal of the knowledge graph and customer journey.

In some embodiments, intelligence engine 106b uses task states to query the knowledge graph as part of the initialization process. When engine 106b uses task states to query the graph, engine 106b can utilize a node name associated with the task node to begin the graph search and traversal. For example, given the user state and information known about the user, engine 106bdetermines that the user has a total income amount on file, engine 106b recognizes that the task is complete and engine 106b can continue down the graph to subsequent nodes. In this example, the node name of the income amount node is “IncomeES.” Intelligence engine 106b instantiates the knowledge graph (e.g., from a graphml file using the NetworkX python package for graph creation and traversal (available at networkx.org)) and engine 106b can perform graph searches as illustrated below to collect and process the next available nodes of the graph:

nx.descendants_at_distance(graph_obj, task, 1)

Above is an example of such a search. ‘nx’ is the NetworkX package, ‘graph_obj’ is the graph loaded into memory from the graphml file, ‘task’ is the node from which engine 106b will start the search, and 1 is how many “hops” away from that starting or seed node that will be searched. This can similarly be done in Cypher (Neo4j) with the line:

MATCH(N)−[r*1 . . . 1]->(b) Where N.nickname=“IncomeES” RETURN b

From the collected nodes, engine 106b can then cross reference with state and continue the search iteratively until there are no more completed nodes to traverse from. This provides engine 106b with a full list of uncompleted nodes for which the user should be engaged, utilizing the content mapped to those task nodes.

After selection of the seed node by knowledge graph seed selector 304, knowledge traversal module 306 analyzes the task and the recommended digital content item(s) contained in the seed node. Module 306 transmits an identifier for the digital content (e.g., a content ID) associated with the seed node to content selection module 106c. Module 106c retrieves the associated digital content from database(s) 110d using the identifier and generates (step 208) a digital content display for presentation to the user at client computing device 102 using the task and the recommended digital content item(s) from the seed node. In one example, the seed node can comprise a task of ‘request retirement age for user’ and the digital content for the seed node can be a webpage or user interface screen with elements that, when presented to the user via client device 102, enable the user to enter the preferred retirement age. Content selection module 106c retrieves digital content from database(s) 110d that corresponds to the seed node (in this case, webpage content to receive retirement age as entered by the user) and generates a digital content display via web application 108a for client computing device 102. In some embodiments, content selection module 106c generates a customized content display (also called a ‘treatment’) for the user based upon, e.g., user profile information and/or session context information collected by user intent module 106a. For example, the digital content retrieved by module 106c can be a webpage that comprises UI elements enabling the user to provide his or her preferred retirement age. Content selection module 106c can modify the baseline webpage retrieved from database(s) 110d according to one or more parameters identified in the session content information and/or user profile information. For example, content selection module 106c can insert a recommended retirement age for the user as calculated from, e.g., the user's financial profile, into the digital content display. In another example, content selection module 106c can insert an informational section into the digital content display that provides the user with certain criteria or points for consideration when determining their preferred retirement age.

Content selection module 106c (via web application 108a) captures user input associated with the digital content display from client computing device 102 and returns the user input to knowledge graph traversal module 306. Module 306 evaluates the user input provided to the digital content display and traverses (step 210) knowledge graph 107 from the seed node to one of a plurality of connected nodes based upon (i) the response to the digital content display received from client computing device 102 and (ii) a ranking of the plurality of connected nodes based upon expected reward value that a task associated with the connected node is responsive to the user intent. Continuing with the above example, the response to the digital content display may comprise a preferred retirement age as entered by the user of client computing device 102. Knowledge graph traversal module 306 can analyze the user input to determine whether the input satisfies the task represented in the currently active node of knowledge graph 107. In this case, the task is ‘request retirement age for user,’ so module 306 can determine that the task has been completed because module 306 has received a preferred retirement age from the user via the content display.

As mentioned above, nodes in knowledge graph 107 are connected to other nodes as part of a sequence of tasks/sub-tasks for completion. Knowledge graph traversal module 306 can determine one or more other nodes connected to the current node (e.g., by determining the IDs of nodes directly connected to the present node via an edge) and traverse to one of the connected nodes. Module 306 can determine that the task associated with the current node in knowledge graph 107 is completed and identify a connected node that represents the next task and/or sub-task for completion by the user during the journey. In some embodiments, construction of knowledge graph 107 is based upon a task workflow, where each node in the graph corresponds to a task or sub-task of the workflow and traversal of the graph from a start node to one or more intermediate nodes and then to an end node—while also completing each task or sub-task of the traversed nodes—results in completion of the workflow. Therefore, evaluation of a given node in knowledge graph 107 can provide module 306 with an indication of which node or node(s) are sequenced to follow the current node. Module 306 can then traverse the graph from the current node along an edge to another node, which results in updating of the graph state for the user and storing the updated state in journey database 110c. As can be appreciated, module 306 then analyzes the newly-traversed node as described above to generate another content display for client computing device 102 and receive user input in response to the new content display. This process is then repeated for each task or sub-task in the journey until module 306 determines that the workflow represented in the graph has been completed by the user. For example, module 306 can determine that the current node is not connected to any other downstream nodes in the graph—which indicates that the workflow is complete.

In some embodiments, knowledge graph traversal module 306 can evaluate a given node of knowledge graph 107 and determine that the task associated with the node has already been completed—either during a previous communication session and/or upon retrieval and analysis of the session context information and/or user-specific profile information. For example, a node may comprise a task of requesting the user's date of birth, as part of a retirement planning journey. However, module 306 can determine that the user's date of birth has already been captured in the user profile (as stored in database 110a). Module 306 can automatically resolve the current node's task as completed based upon detection of the date of birth in the user profile and traverse to a downstream node in the graph.

The following section provides several exemplary use cases showing how system 100 performs knowledge graph traversal and content recommendation.

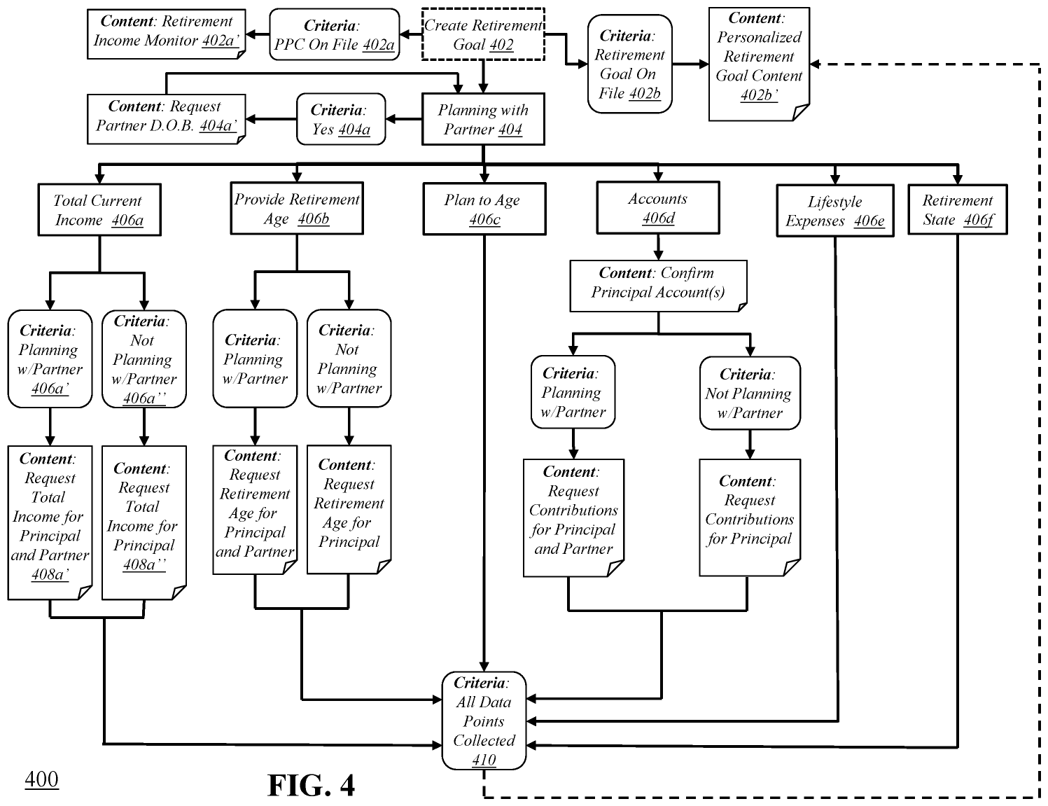

FIG. 4 is a workflow diagram of an exemplary knowledge graph 400 for creating personalized retirement goal content, using system 100 of FIG. 1. As described previously, a user at client computing device 102 can establish a communication session with web application 108a of web server 108, and user intent module 106a of server computing device 106 can determine that the user's intent is to create a retirement goal for retirement planning purposes. For example, the user may have previously accessed webpages tagged as retirement planning or the user may have conducted a phone conversation with a customer service representative during which the user asked several questions about retirement planning goals and tools. User intent module 106a can analyze this information to determine a user intent for the current communication session-i.e., that the user is interested in learning more about creating a customized retirement plan. User intent module 106a can identify the user intent and transmit the user intent to intelligence engine 106b for identification and seeding of a corresponding knowledge graph. Intelligence engine 106b determines that knowledge graph 400 is relevant to creating a retirement goal and providing customized retirement planning content and advice. As one example, user intent module 106a can map the determined user intent to knowledge graph 400 via a predetermined mapping table or other similar function(s).

Intelligence engine 106b also determines that the user at client computing device 102 has not previously interacted with knowledge graph 400 (i.e., interaction database 110b does not contain an in-progress graph state for the user in connection with knowledge graph 400). As a result, intelligence engine 106b identifies the seed node of knowledge graph 400 for the user to be node 402—Create Retirement Goal—which is the start node (or root node) of graph 400.

Intelligence engine 106b initializes an instance of knowledge graph 400 for the user and stores the graph state (e.g., which indicates the current node is node 402) in journey database 110c.

As shown in FIG. 4, node 402 is connected to a plurality of criteria nodes (e.g., nodes 402a, 402b) that are analyzed by intelligence engine 106b to determine how to optimally traverse knowledge graph 400 and provide content to the user. Node 402a instructs intelligence engine 106b to determine whether the user already has a personal plan consultant (PPC) on file-which suggests the user is working with a professional to monitor and manage their retirement goals and may not need to fully complete the retirement planning knowledge graph 400. Engine 106b can analyze user profile information stored in user profile database 110a to determine whether a PPC is associated with the user and if so, intelligence engine 106b traverses knowledge graph 400 to content node 402a′ and provides the content ID stored in node 402a′ to content generation module 106c for generation of a digital content display deliverable to client computing device 102. In this case, content generation module 106c generates a retirement income monitor webpage for the user that incorporates a summary of the user's current retirement accounts and projected income, along with a link to contact their PPC with questions or concerns. Upon reaching node 402a′, intelligence engine 106b determines that the workflow is completed for the user and ends traversal of knowledge graph 400.

Criteria node 402b instructs intelligence engine 402a to determine whether the user already has a retirement goal on file—which indicates that the user has previously interacted with and/or completed the workflow in knowledge graph 400. Engine 106b can analyze user profile information stored in user profile database 110a and/or graph state information stored in journey database 110c to determine whether the user has previously completed the retirement goal planning process. If so, intelligence engine 106b traverses knowledge graph 400 to content node 402b′ and provides the content ID stored in node 402b′ to content generation module 106c. In this case, content generation module 106c generates personalized retirement goal content (e.g., goal tracker, investment/savings advice, etc.) based upon the existing retirement goal information associated with the user, for display on client computing device 102. Upon reaching node 402b′, intelligence engine 106b determines that the workflow is completed for the user and ends traversal of knowledge graph 400.

If neither of the criteria in nodes 402a or 402b are satisfied, intelligence engine 106b identifies node 404 as containing the next task in the workflow and traverses knowledge graph 400 to node 404—Planning with Partner—which relates to the task of determining whether the user at client computing device 102 is planning for retirement with a partner (e.g., spouse) or only for themselves. Intelligence engine 106b analyzes user profile information stored in user profile database 110a and/or graph state information stored in journey database 110c to determine whether the user is planning for retirement with a partner. As part of the task of node 404, intelligence engine 106b evaluates criteria node 404a and if the user is planning with a partner, engine 106b traverses to content node 404a′ and provides the content ID stored in node 404a′ to content generation module 106c. In this case, content generation module 106c generates a user interface with elements to enable the user to enter their partner's date of birth, for display on client computing device 102. After content generation module 106c receives user input in response to the content generated via node 404a′, intelligence engine 106b traverses knowledge graph 400 back to node 404 to continue with the planning workflow.

As shown in FIG. 4, intelligence engine 106b can traverse to each of connected nodes 406a, 406b, 406c, 406d, 406e, and 406f to carry out separate data collection tasks as part of the overall planning workflow. In some embodiments, intelligence engine 106b traverses each of the nodes 406a-406e concurrently to request information from the user of client computing device 102 that is relevant to the planning workflow. For example, engine 106b traverses the knowledge graph to node 406a—Total Current Income—and evaluates each of the criteria nodes 406a′, 406a″ to determine which edge to traverse in the graph 400 to reach a corresponding content node 408a′, 408a″. Criteria node 406a′ is satisfied when the user is planning for retirement with a partner, while criteria node 406a″ is satisfied when the user is not planning for retirement with a partner. Intelligence engine 106b evaluates the user profile information to determine the planning status for the user and traverses knowledge graph 400 to either content node 408a′ or 408a″ depending upon which criterion applies. Upon reaching node 408a′ or 408a″, engine 106b provides the associated content ID to content generation module 106c. In this case, content generation module 106c generates a user interface with elements to enable the user to enter the total income of the user (also called ‘principal’) and their partner (node 408a′) or the total income of only the user (node 408a″), for display on client computing device 102. After content generation module 106c receives user input in response to the user interface display via node 408a′ or 408a″, intelligence engine 106b traverses knowledge graph 400 back to node 410 to continue with the planning workflow. As described above, intelligence engine 106b concurrently traverses other portions of knowledge graph 400 for each of nodes 406b-406e to request other types of information from the user that may be relevant to creating a retirement goal, by generating content displays that enable the user to provide such information and receiving responses to such content displays for continued traversal of graph 400. For each node 406a-406e, intelligence engine 106b traverses knowledge graph 400 to reach node 410.

Node 410 is a criteria node that determines whether all necessary data points are collected (via evaluation of nodes 406a-406e) in order to generate retirement goal content for the user. Intelligence engine 106b determines whether the criterion is met and if so, engine 106b traverses the graph to node 402b′. As described previously, engine 106b provides the content ID stored in node 402b′ to content generation module 106c. In this case, content generation module 106c generates personalized retirement goal content (e.g., goal tracker, investment/savings advice, etc.) based upon the retirement goal information associated with the user that was captured during the current communication session due to traversal of graph 400, for display on client computing device 102. Upon reaching node 402b′, intelligence engine 106b determines that the workflow is completed for the user and ends traversal of knowledge graph 400. If intelligence engine 106b determines that the criterion of node 410 is not met, engine 106b can traverse graph 400 to one or more of nodes 406a-406e for continued collection of user information.

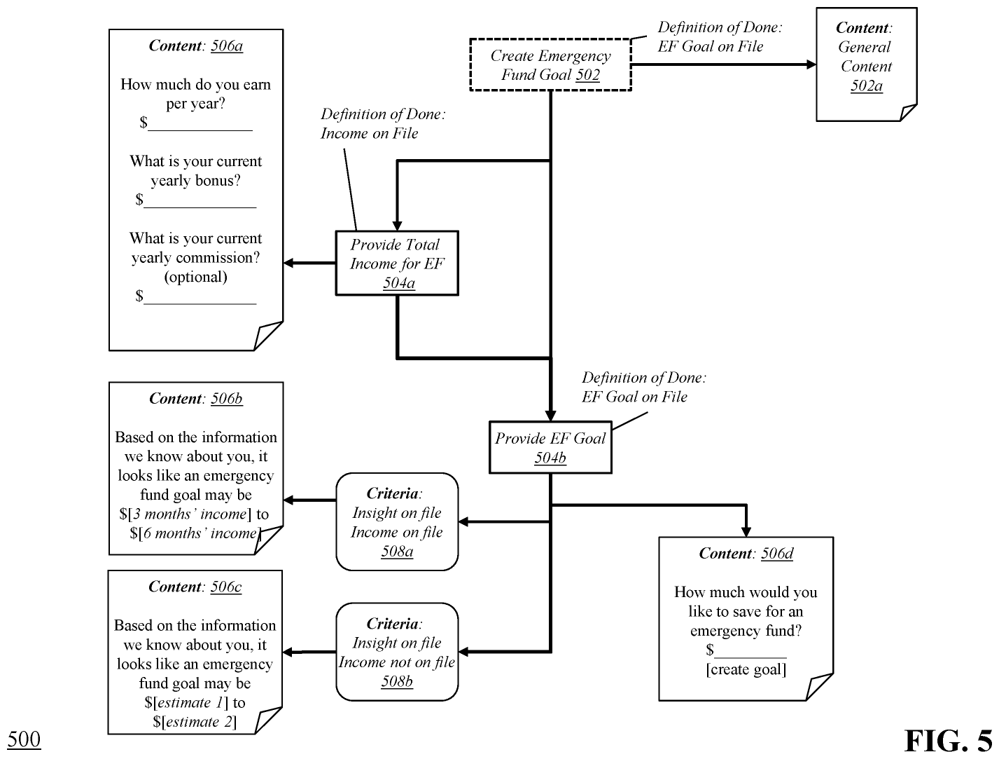

FIG. 5 is a diagram of an exemplary use case of a knowledge graph 500 for creating personalized emergency fund goal content, using system 100 of FIG. 1. As described previously, a user at client computing device 102 can establish a communication session with web application 108a of web server 108, and user intent module 106a of server computing device 106 can determine that the user's intent is to create an emergency fund goal for financial planning purposes. For example, the user may have previously accessed webpages tagged as emergency fund-related or the user may have conducted a phone conversation with a customer service representative during which the user asked several questions about financial planning goals and tools. User intent module 106a can analyze this information to determine a user intent for the current communication session—i.e., that the user is interested in learning more about creating a customized emergency fund savings goal. User intent module 106a can identify the user intent and transmit the user intent to intelligence engine 106b for identification and seeding of a corresponding knowledge graph. Intelligence engine 106b determines that knowledge graph 500 is relevant to creating an emergency fund goal and providing customized content and advice. As one example, user intent module 106a can map the determined user intent to knowledge graph 500 via a predetermined mapping table or other similar function.

Intelligence engine 106b also determines that the user at client computing device 102 has not previously interacted with knowledge graph 500 (i.e., interaction database 110b does not contain an in-progress graph state for the user in connection with knowledge graph 500). As a result, intelligence engine 106b identifies the seed node of knowledge graph 500 for the user to be node 502—Create Emergency Fund Goal—which is the start node (or root node) of graph 500. Intelligence engine 106b initializes an instance of knowledge graph 500 for the user and stores the graph state (e.g., which indicates the current node is node 502) in journey database 110c. As can be appreciated, in some embodiments, knowledge graph 500 can be part of a larger knowledge graph (i.e., a sub-task or branch of the larger graph) and upon completion of the emergency fund goal knowledge graph, intelligence engine 106b can continue traversal of the larger graph to perform other content evaluation and delivery tasks.

As shown in FIG. 5, node 502 is connected to a plurality of task nodes (e.g., nodes 504a, 504b) that are traversed by intelligence engine 106b and each of these task nodes is mapped to different content elements at nodes 506a, 506b, 506c and 506d. Node 502 is also mapped directly to another content element (e.g., general financial content) at node 502a. As can be appreciated, the goal of knowledge graph 500 is to determine which content should be shown to the user at client computing device 102. Upon landing at root node 502 of the graph, intelligence engine 106b determines that there is content (node 502a) mapped directly to node 502 and engine 106b adds the content at node 502a to a list of candidate content. As can be appreciated, the content at node 502a is only selected for display to the user at client computing device 102 when the user already has an emergency fund goal on file.

Intelligence engine 106b then traverses graph 500 to all available uncompleted tasks i.e., tasks corresponding to nodes 504a and 504b. As shown in FIG. 5, task node 504a is configured to display content (node 506a) on client device 102 which comprises a user interface requesting the user's total income to be used in creating an emergency fund goal. Intelligence engine 106b adds the content at node 506a to the list of candidate content. As can be appreciated, the content at node 506a is only selected for display to the user at client computing device 102 when the user does not have a total income amount stored in their user profile. In this example use case, intelligence engine 106b determines that the user does not have a total income amount on file.

Similarly, intelligence engine 106b traverses to task node 504b and adds the content mapped to node 504b to the list of candidate content. As shown in FIG. 5, there are three different content elements (at nodes 506b, 506c, and 506d) mapped to node 504b. Content element at node 506d is mapped directly to node 504b, while the other two content elements (at nodes 506b and 506c) are behind criteria nodes 508a and 508b, respectively. Intelligence engine 106b determines whether each of the criteria nodes 508a, 508b is satisfied based upon information stored about the user, such as the user profile. In this case, criteria node 508a cannot be satisfied because the user does not have a total income amount on file-so intelligence engine 106b does not add the content at node 506b to the list of candidate content. However, criteria node 508b is satisfied and intelligence engine 106b adds the content at node 506c to the list of candidate content. For example, when the total income amount is not on file for the user, intelligence engine 106b can evaluate other aspects of information known about the user (e.g., account balances, transaction histories, employment details, etc.) to generate emergency fund goal estimates for insertion into content at node 506c.

Once intelligence engine 106b has generated the list of candidate content by traversing knowledge graph 500 as described above, engine 106b transmits the list of candidate content to content generation module 106c for ranking and selection of the content in the list. Continuing with the above use case, content generation module 106c can rank the content nodes as follows: 1) content node 506a; 2) content node 506c; 3) content node 506d. Therefore, content generation module 106c generates a user interface containing the content at node 506a, in order for content generation module 106c to capture the user's total income amount for storage in the user's profile and use for future content recommendation. Then, the user at client computing device 102 is provided with a user interface containing the content at node 506c, so the user can see an estimate of potential emergency fund savings goals. Finally, the user at client computing device 102 is provided with a user interface containing the content at node 506d, which asks the user to provide a target amount for emergency fund savings.

As can be appreciated, in the event that the user does not complete all of the tasks in the planning workflow during a single communication session, intelligence engine 106b beneficially stores the in-progress graph state associated with knowledge graph 500 in journey database 110c for later resumption of the workflow by the user. For example, a user may not have all of the required information ready to complete a retirement planning goal creation workflow—e.g., the user may not have the exact value of their partner's total income. As a result, the user can disconnect from the communication session (e.g., by closing a browser window or logging out of the session). Instead of requiring the user to start the retirement planning workflow from the beginning when the user accesses web application 108a in the future, intelligence engine 106b stores the current state of knowledge graph 500 (i.e., the graph ID and node ID at which the user terminated the session) in journey database 110c. Then, when the user subsequently accesses web application 108a to resume the workflow, intelligence engine 106b automatically initializes knowledge graph 500 according to the stored graph state and resumes traversal of the graph. This mechanism provides an efficient and seamless user experience for guided content recommendation, which leads to increased user satisfaction and engagement with the content recommendation tool.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites.

The computer program can be deployed in a cloud computing environment (e.g., Amazon® AWS, Microsoft® Azure, IBM® Cloud™). A cloud computing environment includes a collection of computing resources provided as a service to one or more remote computing devices that connect to the cloud computing environment via a service account—which allows access to the aforementioned computing resources. Cloud applications use various resources that are distributed within the cloud computing environment, across availability zones, and/or across multiple computing environments or data centers. Cloud applications are hosted as a service and use transitory, temporary, and/or persistent storage to store their data. These applications leverage cloud infrastructure that eliminates the need for continuous monitoring of computing infrastructure by the application developers, such as provisioning servers, clusters, virtual machines, storage devices, and/or network resources. Instead, developers use resources in the cloud computing environment to build and run the application, and store relevant data.

Method steps can be performed by one or more processors executing a computer program to perform functions of the invention by operating on input data and/or generating output data. Subroutines can refer to portions of the stored computer program and/or the processor, and/or the special circuitry that implement one or more functions. Processors suitable for the execution of a computer program include, by way of example, special purpose microprocessors specifically programmed with instructions executable to perform the methods described herein, and any one or more processors of any kind of digital or analog computer. Generally, a processor receives instructions and data from a read-only memory or a random-access memory or both. The essential elements of a computer are a processor for executing instructions and one or more memory devices for storing instructions and/or data. Exemplary processors can include, but are not limited to, integrated circuit (IC) microprocessors (including single-core and multi-core processors). Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), an ASIC (application-specific integrated circuit), Graphics Processing Unit (GPU) hardware (integrated and/or discrete), another type of specialized processor or processors configured to carry out the method steps, or the like.

Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices (e.g., NAND flash memory, solid state drives (SSD)); magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above-described techniques can be implemented on a computing device in communication with a display device, e.g., a CRT (cathode ray tube), plasma, or LCD (liquid crystal display) monitor, a mobile device display or screen, a holographic device and/or projector, for displaying information to the user and a keyboard and a pointing device, e.g., a mouse, a trackball, a touchpad, or a motion sensor, by which the user can provide input to the computer (e.g., interact with a user interface element). The systems and methods described herein can be configured to interact with a user via wearable computing devices, such as an augmented reality (AR) appliance, a virtual reality (VR) appliance, a mixed reality (MR) appliance, or another type of device. Exemplary wearable computing devices can include, but are not limited to, headsets such as Meta™ Quest 3™ and Apple® Vision Pro™.

Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above-described techniques can be implemented in a distributed computing system that includes a back-end component. The back-end component can, for example, be a data server, a middleware component, and/or an application server. The above-described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above-described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN),), a private IP network, an IP private branch exchange (IPBX), a wireless network (e.g., radio access network (RAN), Bluetooth™, near field communications (NFC) network, Wi-Fi™, WiMAX™, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), cellular networks, and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE), cellular (e.g., 4G, 5G), and/or other communication protocols.

Devices of the computing system can include, for example, a computer, a computer with a browser device, a telephone, an IP phone, a mobile device (e.g., cellular phone, personal digital assistant (PDA) device, smartphone, tablet, laptop computer, electronic mail device), and/or other communication devices. The browser device includes, for example, a computer (e.g., desktop computer and/or laptop computer) with a World Wide Web browser (e.g., Chrome™ from Google, Inc., Safari™ from Apple, Inc., Microsoft® Edge® from Microsoft Corporation, and/or Mozilla® Firefox from Mozilla Corporation). Mobile computing devices include, for example, an iPhone® from Apple Corporation, and/or an Android™-based device. IP phones include, for example, a Cisco® Unified IP Phone 7985G and/or a Cisco® Unified Wireless Phone 7920 available from Cisco Systems, Inc.

The methods and systems described herein can utilize artificial intelligence (AI) and/or machine learning (ML) algorithms to process data and/or control computing devices. In one example, a classification model, is a trained ML algorithm that receives and analyzes input to generate corresponding output, most often a classification and/or label of the input according to a particular framework.

Comprise, include, and/or plural forms of each are open ended and include the listed parts and can include additional parts that are not listed. And/or is open ended and includes one or more of the listed parts and combinations of the listed parts.

One skilled in the art will realize the subject matter may be embodied in other specific forms without departing from the spirit or essential characteristics thereof. The foregoing embodiments are therefore to be considered in all respects illustrative rather than limiting the subject matter described herein.

What is claimed is:

1. A computer system for guided content recommendation using a knowledge graph, the system comprising:
a plurality of digital content databases, each digital content database comprising one or more digital content items;
a computer data store comprising (i) historical interaction information for each of a plurality of users and (ii) historical graph traversal information for each of the plurality of users; and
a server computing device in communication with the plurality of digital content databases and the computer data store, the server computing device comprising a memory to store computer-executable instructions and a processor that executes the computer-executable instructions to:
determine a user intent associated with a user interaction request received from a remote computing device, including analyzing historical interaction information associated with a user of the remote computing device from the computer data store;
determine a graph state associated with the user of the remote computing device based upon historical graph traversal information for the user in the computer data store;
identify a seed node of a content recommendation knowledge graph based upon the user intent and the graph state, the seed node associated with (i) a task for completion by the user and (ii) one or more recommended digital content items from the digital content item databases;
generate a digital content display for presentation to the user at the remote computing device using the task and the recommended digital content items from the seed node;
traverse the content recommendation knowledge graph from the seed node to one of a plurality of connected nodes based upon (i) a response to the digital content display received from the remote computing device and (ii) a ranking of the plurality of connected nodes based upon an expected reward value that a task associated with the connected node is responsive to the user intent.

2. The system of claim 1, wherein the content recommendation knowledge graph comprises a plurality of nodes each connected to one or more other nodes in the knowledge graph via an edge, and each node comprising (i) a task for completion by the user and (ii) one or more recommended digital content items from the digital content item databases.

3. The system of claim 1, wherein the historical interaction information comprises one or more of: webpages accessed by the user during one or more browsing sessions, and context information for voice call sessions or text chat sessions associated with the user.

4. The system of claim 2, wherein the historical graph traversal information comprises one or more of: identification of nodes in the content recommendation knowledge graph associated with one or more completed tasks, and identification of nodes in the content recommendation knowledge graph associated with one or more in-progress tasks.

5. The system of claim 1, wherein the digital content display comprises at least one of the digital content items from the seed node and a feedback element configured to receive a response from the user of the remote computing device.

6. The system of claim 5, wherein the digital content items comprise webpages, articles, images, videos, and content cards.

7. The system of claim 1, wherein each node in the content recommendation knowledge graph is mapped to one or more predicted intents.

8. The system of claim 1, wherein traversing the content recommendation knowledge graph from the seed node to one of a plurality of connected nodes comprises:
identifying one or more of the connected nodes that aligns with the response to the digital content display received from the remote computing device;
determining an expected reward value for each identified connected node that a task associated with the connected node is responsive to the user intent; and
selecting one of the identified connected nodes for traversal based upon the expected reward values.

9. The system of claim 8, wherein the task associated with the connected node comprises a subtask of the task associated with the seed node.

10. The system of claim 1, wherein the server computing device determines that the task associated with the seed node is complete upon receiving the response to the digital content display.

11. A computerized method of guided content recommendation using a knowledge graph, the method comprising:
determining, by a server computing device, a user intent associated with a user interaction request received from a remote computing device, including analyzing historical interaction information associated with a user of the remote computing device;
determining, by the server computing device, a graph state associated with the user of the remote computing device based upon historical graph traversal information for the user;
identifying, by the server computing device, a seed node of a content recommendation knowledge graph based upon the user intent and the graph state, the seed node associated with (i) a task for completion by the user and (ii) one or more recommended digital content items;
generating, by the server computing device, a digital content display for presentation to the user at the remote computing device using the task and the recommended digital content items from the seed node;
traversing, by the server computing device, the content recommendation knowledge graph from the seed node to one of a plurality of connected nodes based upon (i) a response to the digital content display received from the remote computing device and (ii) a ranking of the plurality of connected nodes based upon expected reward value that a task associated with the connected node is responsive to the user intent.

12. The method of claim 11, wherein the content recommendation knowledge graph comprises a plurality of nodes each connected to one or more other nodes in the knowledge graph via an edge, and each node comprising (i) a task for completion by the user and (ii) one or more recommended digital content items from the digital content item databases.

13. The method of claim 11, wherein the historical interaction information comprises one or more of: webpages accessed by the user during one or more browsing sessions, and context information for voice call sessions or text chat sessions associated with the user.

14. The method of claim 12, wherein the historical graph traversal information comprises one or more of: identification of nodes in the content recommendation knowledge graph associated with one or more completed tasks, and identification of nodes in the content recommendation knowledge graph associated with one or more in-progress tasks.

15. The method of claim 11, wherein the digital content display comprises at least one of the digital content items from the seed node and a feedback element configured to receive a response from the user of the remote computing device.

16. The method of claim 15, wherein the digital content items comprise webpages, articles, images, videos, and content cards.

17. The method of claim 11, wherein each node in the content recommendation knowledge graph is mapped to one or more predicted intents.

18. The method of claim 11, wherein traversing the content recommendation knowledge graph from the seed node to one of a plurality of connected nodes comprises:
identifying one or more of the connected nodes that aligns with the response to the digital content display received from the remote computing device;
determining an expected reward value for each identified connected node that a task associated with the connected node is responsive to the user intent; and
selecting one of the identified connected nodes for traversal based upon the expected reward values.

19. The method of claim 18, wherein the task associated with the connected node comprises a subtask of the task associated with the seed node.

20. The method of claim 11, wherein the server computing device determines that the task associated with the seed node is complete upon receiving the response to the digital content display.
